(19) United States
(12) Patent Application Publication
(10) Pub. No.: US 2023/0356960 A1
(43) Pub. Date: Nov. 9, 2023

(54) CONVEYOR ASSEMBLY SUITABLE FOR USE IN ASSOCIATION WITH THE ASSEMBLING OF COMPONENTS

(71) Applicant: JR Automation Technologies, LLC, Holland, MI (US)

(72) Inventors: Dave TerHaar, Holland, MI (US); Robb Ripley, Holland, MI (US); Matt Pawlowski, Holland, MI (US); Scott Beute, Holland, MI (US); Eugene Peyerk, Holland, MI (US); Dan Baumann, Holland, MI (US)

(21) Appl. No.: 18/197,693

(22) Filed: May 15, 2023

Related U.S. Application Data
(63) Continuation of application No. 17/224,059, filed on Apr. 6, 2021, now abandoned.
(60) Provisional application No. 63/006,033, filed on Apr. 6, 2020.

(51) Int. Cl. B65G 47/22; B65G 47/88; B65G 41/00; B65G 37/00; B65G 17/06

(52) U.S. Cl. CPC B65G 47/22; B65G 47/8815; B65G 41/003; B65G 37/005; B65G 17/065

(57) ABSTRACT

A conveyor assembly comprising a frame, a first conveyor subassembly, a second conveyor subassembly, a transverse conveyor adjustment assembly and a position adjustment assembly. The first and second conveyor subassemblies are configured so as to be transversely moved relative to each other so as to be closer together or further apart. The position adjustment assembly facilitates the adjustment of a part on the conveyor relative to the conveyor as the part proceeds from the first end to the second end.

### CROSS-REFERENCE TO RELATED APPLICATION

This present application is a continuation of U.S. patent application Ser. No. 17/224,059 filed on Apr. 6, 2021, entitled “CONVEYOR ASSEMBLY SUITABLE FOR USE IN ASSOCIATION WITH THE ASSEMBLING OF COMPONENTS”, which claims priority from U.S. Provisional Patent Application Ser. No. 63/006,033 filed on Apr. 6, 2020, entitled “CONVEYOR ASSEMBLY SUITABLE FOR USE IN ASSOCIATION WITH THE ASSEMBLING OF COMPONENTS”, the entire disclosure of which is hereby incorporated by reference in its entirety.

### BACKGROUND OF THE DISCLOSURE

### 1. Field of the Disclosure

The disclosure relates in general to part, component and material placement and positioning during assembly operations, and more particularly, to a conveyor assembly that is suitable for use in association with the assembling of components. For example, and not to be deemed limiting, the conveyor assembly is well suited to provide parts to a welding station (or welding stations) wherein the conveyor assembly brings parts to a robot and the robot can pick parts from the end of the conveyor assembly. The use of the conveyor system is not limited to such use, and other uses are likewise contemplated.

### 2. Background Art

The movement of parts along conveyors in assembly stations or assembly processes is known. That is, conveyors have long been a part of the process of moving parts into and out of different assembly stations.

While the movement of such parts on conveyors has been successful, problems persist. For example, in many operations, a robot or the like is configured to pick up a part. It is desirable to be able to position the part in a desired orientation with minimal effort and minimal intervention by users or operators. Some solutions have been developed that, for example rely on the dragging of parts on fixed surfaces during the conveying process. Problematically, this can lead to wear on the parts and wear on the conveyor, as well as marring of each.

### SUMMARY OF THE DISCLOSURE

The disclosure is directed, in an aspect to a conveyor assembly for conveying a part therealong. The conveyor assembly comprises a frame, a first conveyor, a second conveyor and a transverse conveyor adjustment member. The first conveyor is attached to the frame. The first conveyor includes a plurality of conveyor links coupled together. A pin extends from a plurality of the plurality of conveyor links. The second conveyor is attached to the frame. The second conveyor includes a plurality of conveyor links coupled together. A pin extends from a plurality of the plurality of conveyor links. A transverse conveyor adjustment member is associated with the frame, and, structurally configured to direct at least one of the first conveyor and the second conveyor in a first transverse direction and in a second transverse direction opposite to the first transverse direction. The first transverse direction positions the first conveyor and the second conveyor closer to each other. The second transverse direction positions the first conveyor and the second conveyor further apart from each other.

In some configurations, the first conveyor further includes a first conveyor drive motor and the second conveyor further includes a second conveyor drive motor.

In some configurations, the transverse conveyor adjustment member comprises a pair of lead screws associated with one of the first and second conveyors. Rotation of the pair of lead screws in a first direction directs the first conveyor closer to the second conveyor, and rotation of the pair of lead screws in a second direction directs the first conveyor further away from the second conveyor.

In some configurations, the first conveyor and the second conveyor are parallel to each other.

In some configurations, the pin is positionable in a plurality of positions on at least one of the plurality of conveyor links.

In some configurations, the conveyor assembly further includes a position adjusting assembly, structurally configured to engage a part on the conveyor so as to facilitate movement of the part relative to the conveyor.

In some configurations, the position adjusting assembly is structurally configured to facilitate movement of the part relative to the pin of at least one of the first conveyor and the second conveyor.

In some configurations, the position adjusting assembly comprises a first beam assembly associated with the first conveyor and a second beam assembly associated with the second conveyor. The first and second beam assemblies each including a beam movable relative to a respective one of the first and second conveyor.

In some configurations, the first beam assembly further comprises a first beam and a first beam actuator. The first beam is positioned to a first side of the first conveyor, the first beam has a part contact edge. The first beam actuator is coupled to the beam. The first beam actuator is structurally configured to move the first beam relative to an upper surface of the first conveyor between a first position and a second position. In a first position, the part contact edge is positioned below the upper surface of the first conveyor. In a second position, the part contact edge extends above the upper surface of the first conveyor.

In some configurations, the movement between the first and second positions comprises a linear movement in an upward and downward direction.

In some configurations, the movement between the first and second positions comprises movement that is in an upward and downward direction and also in a direction that is parallel to the direction of travel of the conveyor.

In some configurations, the first beam assembly and the second beam assembly are substantially identical in configuration.

In some configurations, the first beam actuator further comprises a motor that is coupled to an eccentric drive so as to direct the first beam in an upward and downward direction, as well as in a forward and rearward direction.

In some configurations, the position adjusting assembly further comprises a plurality of downwardly projecting fingers extending over at least one of the first conveyor, the second conveyor and between the first conveyor an the second conveyor. The projecting fingers have a proximal end and a distal end. The distal end is positionable in the path of the part positioned on the conveyor. Each of the projecting fingers are rotatable about a pivot axle that extends transverse to the first and second conveyors.

In some configurations, the pivot axle is orthogonal to the first conveyor and the second conveyor.

In some configurations, the downwardly projecting fingers extend across the first conveyor and the second conveyor.

In some configurations, the position adjusting assembly further comprises a pin assembly including a pin member selectively extendable into a path of a part, and an actuator directing the pin member into and out of the path of the part.

In some configurations, a biasing member extends between the frame and the actuator biasing the actuator in a direction opposite that of the movement of the conveyor.

In another aspect of the disclosure, the disclosure is directed to a conveyor assembly for conveying a part therealong. The conveyor assembly includes a frame, a first conveyor and a position adjusting assembly. The first conveyor is attached to the frame. The first conveyor includes a plurality of conveyor links coupled together. A pin extends from a plurality of the plurality of conveyor links. The position adjusting assembly which is structurally configured to engage a part on the conveyor so as to facilitate movement of the part relative to the conveyor.

In another aspect of the disclosure, the disclosure is directed to a method of adjusting the a part on a conveyor comprising the steps of: providing a first conveyor, the first conveyor including a plurality of conveyor links coupled together, with a pin extending from a plurality of the plurality of conveyor links; positioning a part on the first conveyor, the part being interfaceable with at least one pin of the pins extending from the plurality of the plurality of conveyor links; engaging the part with a position adjusting assembly; allowing the part to move relative to the at least one pin through engagement of the part with the position adjusting assembly; and unengaging the part from the position adjusting assembly.

### BRIEF DESCRIPTION OF THE DRAWINGS

The disclosure will now be described with reference to the drawings wherein:

FIG. 1 of the drawings is a perspective view of the conveyor assembly of the present disclosure;

FIG. 2 of the drawing is a perspective view of the conveyor assembly of the present disclosure;

FIG. 3 of the drawings is a perspective view of the conveyor assembly of the present disclosure;

FIG. 4 of the drawings is a partial perspective view of the conveyor assembly of the present disclosure;

FIG. 5 of the drawings is a partial perspective view of a portion of a configuration of the position adjusting assembly;

FIG. 6 of the drawings is a partial perspective view of a portion of the configuration of the position adjusting assembly showing, in particular, the first beam actuator;

FIG. 7 of the drawings is a partial perspective view of a portion of the configuration of the position adjusting assembly showing, in particular, the first beam actuator;

FIGS. 8a through 8d of the drawings are a sequential schematic representation of the structure of and operation of a configuration of the position adjusting assembly of the present disclosure;

FIGS. 9a through 9d of the drawings are a sequential schematic representation of the structure of and operation of another configuration of the position adjusting assembly of the present disclosure;

FIGS. 10a through 10d of the drawings are a sequential schematic representation of the structure of and operation of another configuration of the position adjusting assembly of the present disclosure;

FIG. 10e is a schematic representation of a top view of the configuration of the position adjusting assembly of FIGS. 10a through 10d; and

FIG. 11a through 11d of the drawings are a sequential schematic representation of the structure of and operation of another configuration of the position adjusting assembly of the present disclosure.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

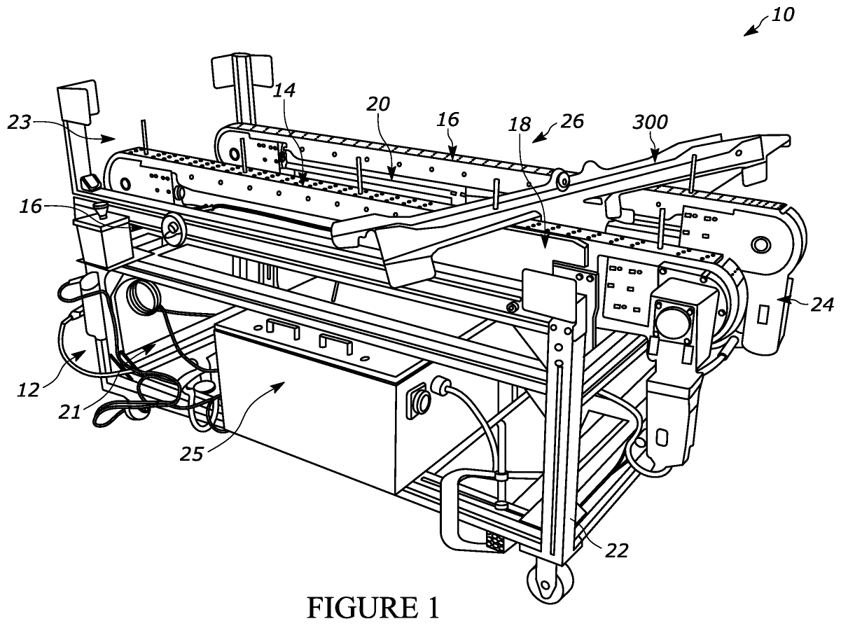

Referring now to the drawings and in particular to FIG. 1, the conveyor assembly is shown generally at 10. The conveyor assembly, as identified above, can be utilized as part of a system that is configured to assemble components. For example, the conveyor assembly is well suited for use in association with welding stations, wherein robots can be utilized to transfer components (termed parts in much of the disclosure below) from the conveyor (proximate an end thereof) to a welder or the like. Of course, the conveyor assembly has other uses and is not limited to such a use. In turn, this use is provided as solely an illustrative example and is not to be deemed limiting.

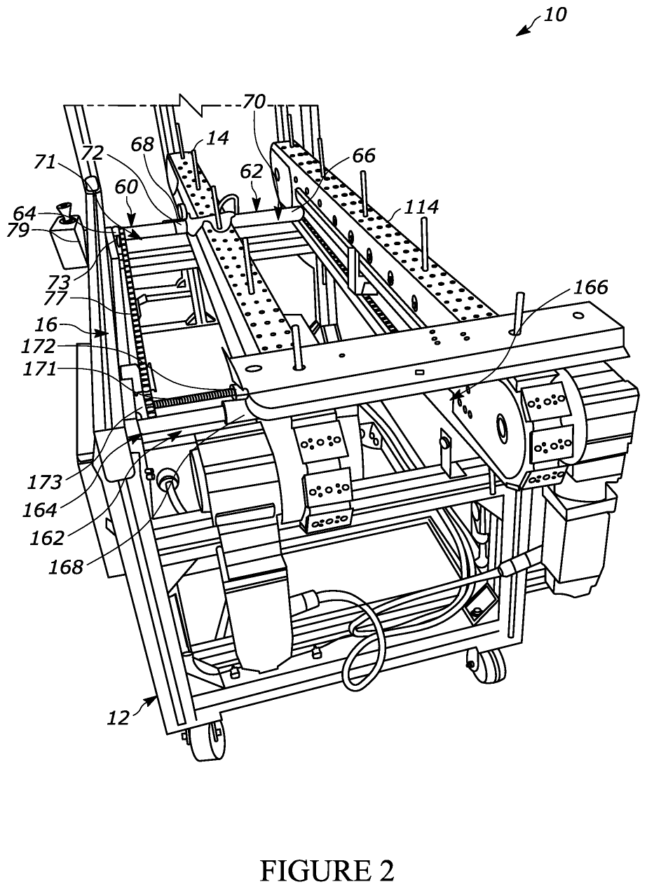

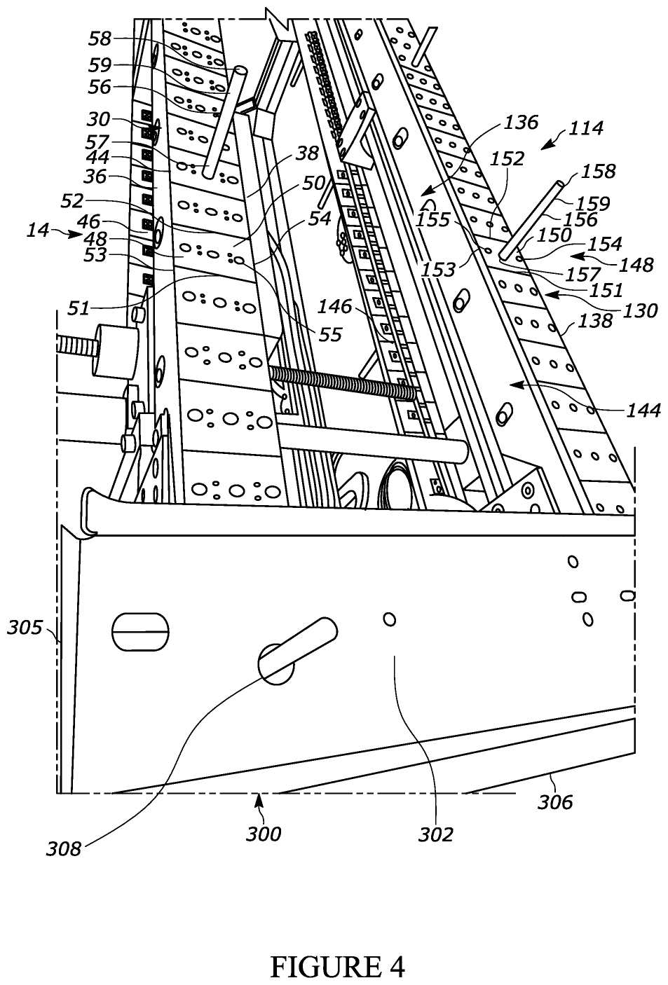

With reference to FIGS. 1 through 4, the conveyor assembly 10 includes frame 12, first conveyor subassembly 14, second conveyor subassembly 114, transverse conveyor adjustment 16 and position adjusting assembly 18. The frame 12 provides the necessary support for the conveyor subassemblies so that they can be adjusted relative to each other, and also provides the necessary support for the different position adjusting assemblies (some of which are mounted directly to the frame, and some of which can be mounted indirectly to the frame). The frame includes upper region 20, lower region 21, and legs 22. The frame extends from first end 23 to second end 24 and spans between first side 25 and second side 26. It will be understood that, preferably, the parts conveyed on the conveyor proceed from a region proximate the first end to a region proximate the second end. The size and configuration of the frame can be modified without limitation. In certain configurations, the frame may be longer, shorter, narrower, longer, straight, curved, inclined, or declined, among other configurations.

The first conveyor subassembly 14 comprises first conveyor frame 30, head sprocket 40, tail sprocket 42, conveyor frame bed 44, conveyor chain 46, conveyor links 48 and first conveyor drive motor 49. The first conveyor frame is generally positioned along the first side of the frame 12 and extends between the first end and the second end of the frame. At or near the second end, the head sprocket 40 is positioned and configured to rotate about axis 41. At or near the first end, the tail sprocket 42 is positioned and configured to rotate about axis 43.

A conveyor chain 46 is provided that is coupled to the head sprocket and the tail sprocket. The chain is directed around the two sprockets and along a conveyor frame bed 44, which may comprise a slider and/or a roller frame bed that provides surfaces along which the chain and/or the conveyor links can travel. In the configuration shown, the conveyor frame bed is positioned below the conveyor links so as not to interfere with the parts that are conveyed on the conveyor. In the configuration shown, the conveyor chain has an upper portion and a lower portion, with the upper portion providing the motive force to direct parts and the lower portion comprising the return portion.

A plurality of conveyor links, such as conveyor link 48 are sequentially positioned along the chain and coupled thereto. They are coupled to the chain such that they generally abut other conveyor links when the chain is moving along the upper portion. Each of the conveyor links 48 is generally of a substantially identical configuration (while variations are contemplated). As such, one of the conveyor links 48 will be described with the understanding that the other conveyor links are substantially identical.

More specifically, the conveyor link includes an upper surface 50 which is defined by front edge 51, back edge 52, first side edge 53 and second side edge 54. The upper surface, in the configuration shown is substantially planar, and the conveyor link includes a generally uniform thickness. The configuration of the links as shown are substantially rectangular. The conveyor links can be coupled to the underlying conveyor chain 46 in a number of different manners. For example, they may be bolted to links of the chain, or, they may be coupled to the chain, directly or indirectly in a releasable manner.

A plurality of bores, such as bore 55 is defined in the upper surface 50 of the conveyor links. In the configuration shown, three spaced apart bores are spaced between the first side edge 53 and the second side edge 54 along a transverse axis that is substantially parallel to the front edge 51 and the back edge 52 and substantially equidistantly spaced from each of the front edge and the back edge. It will be understood that each of the bores 55 may have the same dimensions (i.e., substantially circular) and may be threaded. Of course, other configurations are likewise contemplated, such as keyed configurations or unkeyed configurations that have various cross-sections (polygonal, oval, elliptical, arbitrary, etc.).

In the configuration shown, a pin 56 may be coupled to the conveyor by interfacing the same with one of the bores 55. In the configuration shown, an exemplary pin 56 includes first end 57, second end 58 and outer surface 59. In the configuration shown, the pin comprises a generally uniform cylindrical configuration having a rounded second end, and a first end that is threaded so as to matingly engage the bores 55 of the conveyor links.

In the configuration shown, a plurality of pins 56 are coupled to ones of the conveyor links. In the configuration shown, a pin is coupled to a central one of the bores of conveyor links that are spaced apart from each other. As will be explained below, based on the parts that are to be supplied, the type of assembly equipment and other considerations, different numbers of pins can be coupled to different ones of the bores of the conveyor links as determined to be necessary.

The first conveyor drive motor comprises a servomotor that is coupled, in the configuration shown, to the head sprocket 40 and provides motive force to rotate the head sprocket. It will be understood to one of ordinary skill in the art that the servo motor can be programmed to rotate in any number of different fashions, speeds, and the like as desired. And, that such motive force will translate to movement of the conveyor chain and the conveyor links along the conveyor frame.

Similarly, the second conveyor subassembly 114 comprises second conveyor frame 130, head sprocket 140, tail sprocket 142, conveyor frame bed 144, conveyor chain 146, conveyor links 148 and second conveyor drive motor 149. The second conveyor frame is generally positioned along the second side of the frame 12 and extends between the first end and the second end of the frame. At or near the second end, the head sprocket 140 is positioned and configured to rotate about axis 141. At or near the first end, the tail sprocket 142 is positioned and configured to rotate about axis 143. In the configuration shown, the first and second conveyor subassemblies 14, 114 are positioned in a substantially parallel configuration that is spaced apart. That is, the first conveyor subassembly is positioned on the first side of the frame relative to the second conveyor subassembly which is positioned on the second side of the frame relative to the first conveyor subassembly. It will be understood that in other configuration more than two conveyors may be provided. For example, a third conveyor may be positioned between the first and second conveyor. In still other configurations greater than three conveyors may be provided.

As with the first conveyor, the second conveyor includes a conveyor chain 146 that is coupled to the head sprocket and the tail sprocket. The chain is directed around the two sprockets and along a conveyor frame bed 144, which may comprise a slider and/or a roller frame bed that provides surfaces along which the chain and/or the conveyor links can travel. In the configuration shown, the conveyor frame bed is positioned below the conveyor links so as not to interfere with the parts that are conveyed on the conveyor. In the configuration shown, the conveyor chain has an upper portion and a lower portion, with the upper portion providing the motive force to direct parts and the lower portion comprising the return portion.

A plurality of conveyor links, such as conveyor link 48 are sequentially positioned along the chain and coupled thereto. They are coupled to the chain such that they generally abut other conveyor links when the chain is moving along the upper portion. Each of the conveyor links 148 is generally of a substantially identical configuration (while variations are contemplated). And, preferably, the conveyor links 148 are substantially identical to the conveyor links 48, in the configuration shown.

As with the conveyor links of the first conveyor subassembly, the conveyor link 148 includes an upper surface 150 which is defined by front edge 151, back edge 152, first side edge 153 and second side edge 154. Of course, it is contemplated that the conveyor links of the second conveyor subassembly may be different than those of the first conveyor subassembly.

As with the conveyor links of the first conveyor subassembly, a plurality of bores, such as bore 155 is defined in the upper surface 150 of the conveyor links. In the configuration shown, three spaced apart bores are spaced between the first side edge 153 and the second side edge 154 along a transverse axis that is substantially parallel to the front edge 151 and the back edge 152 and substantially equidistantly spaced from each of the front edge and the back edge. It will be understood that each of the bores 155 may have the same dimensions (i.e., substantially circular) and may be threaded.

As with the conveyor links of the first conveyor subassembly, a pin 156 may be coupled to the conveyor by interfacing the same with one of the bores 155. Pin 156 includes first end 157, second end 158 and outer surface 159. In the configuration shown, the pin comprises a generally uniform cylindrical configuration having a rounded second end, and a first end that is threaded so as to matingly engage the bores 155 of the conveyor links.

The second conveyor drive motor comprises a servomotor that is coupled, in the configuration shown, to the head sprocket 140 and provides motive force to rotate the head sprocket. It will be understood to one of ordinary skill in the art that the servo motor can be programmed to rotate in any number of different fashions, speeds, and the like as desired. And, that such motive force will translate to movement of the conveyor chain and the conveyor links along the conveyor frame. It will be understood that the servomotors of the first and second conveyor drive motor may be combined so that there is a single servomotor that controls the rotation of both of the conveyor assemblies. In the configuration shown, each of the conveyor subassemblies has its own servomotor such that they may be independently controlled (to, for example have different output parameters or the like). Such configurations will be described below.

The transverse conveyor adjustment 16 is configured to adjust the position of the first conveyor subassembly relative to the second conveyor subassembly, in the configuration shown, to bring the first conveyor subassembly closer to or further away from the second conveyor subassembly. In the configuration shown, the transverse conveyor adjustment maintains the parallel relative orientation of the first conveyor subassembly and the second conveyor subassembly.

In the configuration shown, the transverse conveyor adjustment 16 comprises a slidable mount member 60 and a transverse position adjustment 70. The slidable mount member 60 comprises shaft 62 linear bearing 68 as well as shaft 162 and linear bearing 168. The shaft 62 and the shaft 162 are spaced apart from each other and extend transverse to the first conveyor frame. In the configuration shown, the two shafts extend through the frame of the first conveyor, with shaft 62 being near the first end of the conveyor frame and the shaft 162 being near the second end of the conveyor frame.

The first shaft 62 includes first end 64 and second end 66, with the second shaft 162 including first end 164 and second end 166. In the configuration shown, the shafts comprise substantially elongated cylindrical members. Linear bearing 68 is coupled to the frame of the first conveyor subassembly and slidably movable along the first shaft 62. The linear bearing 168 is coupled to the frame of the first conveyor subassembly and slidably movable along the second shaft 162. In other words, the first conveyor subassembly is slidably movable along the first and second shafts 62, 162 through the linear bearings 68, 168 that are coupled thereto. It will be understood that other slidable mounting members may be utilized, such as, for example, linear actuators, ball screw mechanisms, recirculating ball mechanisms, rack and pinion systems and the like.

The transverse position adjustment 70 is shown as comprising first lead screw 71, second lead screw 171, chain drive 77 and rotating adjustment handle 79. The first lead screw 71 is configured to rotate about a longitudinal axis which is generally fixed to the frame and transverse to the first conveyor. The first lead screw 71 interfaces with the first threaded nut 72 which is coupled to the frame of the first conveyor subassembly. Similarly, the second lead screw 171 is configured to rotate about a longitudinal axis which is generally fixed to the frame and transverse to the first conveyor (and parallel to the longitudinal axis of the first lead screw. The second lead screw 171 interfaces with the second threaded nut 172 which is coupled to the frame of the first conveyor subassembly.

The sprocket 73 is fixed to rotate with the first lead screw 71, and second sprocket 173 is fixed to rotate with the second lead screw 171. Chain drive 77 is coupled to both of the sprockets so that rotation of one rotates the other. In the configuration shown, the two sprockets are of the same size so that there is a 1:1 correspondence between the movement of one relative to the movement of the other. And, there is a 1:1 correspondence between the first lead screw and the second lead screw with respect to diameter and pitch, among other properties. Of course, this may be varied depending on the particular configuration and properties desired.

The rotating adjustment handle 79 is fixedly coupled to the first lead screw 71 such that rotation of the adjustment handle rotates the first lead screw. In turn, through the sprockets and chain, such rotation rotates the second lead screw 171. Rotation of the two lead screws relative to the respective first and second threaded nuts that are coupled to the first conveyor subassembly linearly translates the first conveyor subassembly along the shafts of the slidable mount member. It will be understood that rotation in a first direction linearly translates the first conveyor subassembly toward the second conveyor subassembly with rotation in a second direction linearly translating the first conveyor subassembly away from the second conveyor subassembly.

In the configuration shown, it will be understood that the transverse conveyor adjustment is coupled to the first conveyor subassembly with the second conveyor subassembly being substantially fixed to the frame and generally precluded from transverse movement relative to the frame. In other configurations it is contemplated that both the second conveyor assembly and the first conveyor assembly may be adjusted in a transverse position toward and/or away from each other. In still other configurations, only the second conveyor assembly may be movable and the first conveyor assembly may be fixed.

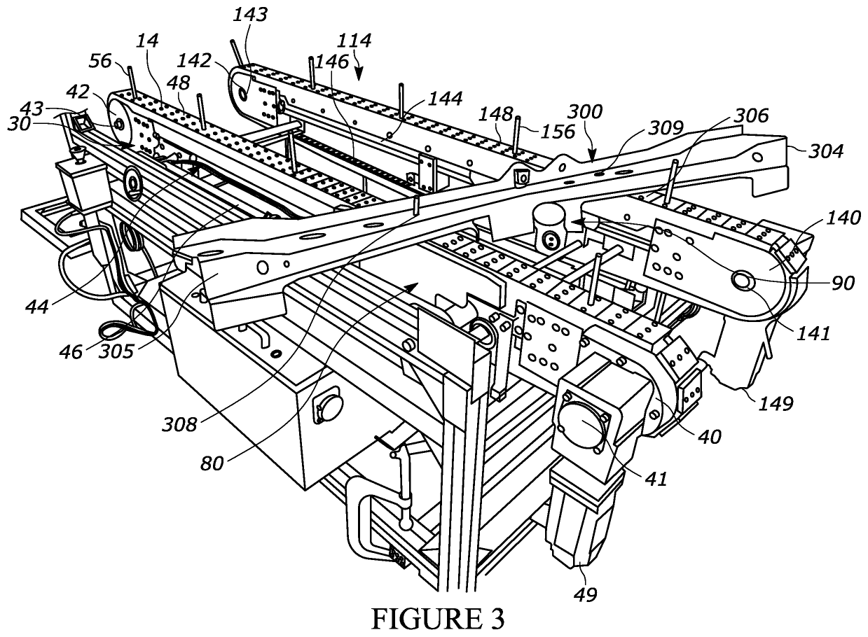

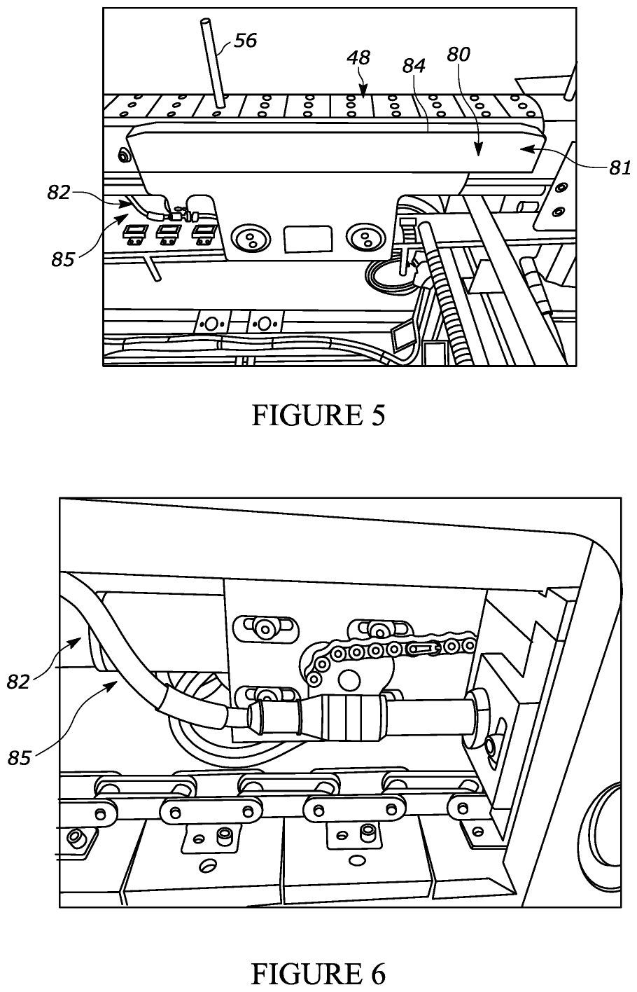

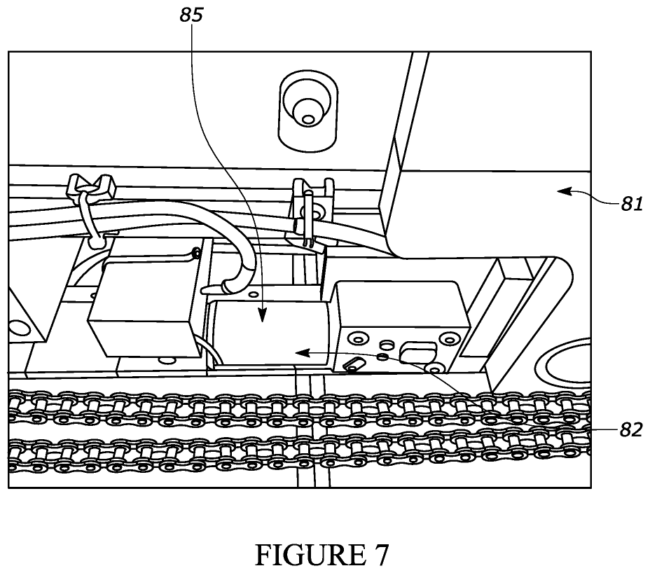

With reference to FIGS. 3 and 5 through 7, in a configuration, the position adjusting assembly 18, is shown as comprising first beam assembly 80 and second beam assembly 90. The first beam assembly will be described with the understanding that the second beam assembly is substantially identical thereto. The first beam assembly comprises a first beam 81, and, a first beam movement actuator 82. The first beam includes a part contact edge 84 at an upper end thereof, wherein the part contact edge is structurally configured to provide an edge upon which the part can be supported thereby. In the configuration shown, the part contact edge 84 comprises a substantially planar upper surface having a first end and a second end. In the configuration shown, the planar surface is substantially parallel to the conveyor passing thereby, while it is contemplated that the part contact edge may comprise an surface that is oblique or partially oblique thereto, or positionable in an oblique configuration. In other configurations, it is contemplated that portions thereof may be perpendicular to the conveyor. It is contemplated that that the edge may likewise be arcuate or of a non-linear configuration or a plurality of combined linear and non-linear segments.

The first beam movement actuator 82 is configured to direct the first beam in, at least an upward/downward direction (i.e., substantially perpendicular to the conveyor passing thereby). In other configurations, the first beam may further be directed in a forward/rearward direction as well (i.e., substantially parallel to the conveyor passing thereby). In some configurations, the first beam movement actuator is configured to direct the first beam in multiple directions, for example, both in the upward/downward and also in the forward/rearward direction.

For example, and not to be deemed limiting, in the configuration shown, the first beam actuator may comprise a structure that is coupled to an eccentrically mounted wheel (to the beam) that can be driven by a chain coupled to, for example a motor, such as motor 85. Other configurations are likewise contemplated, including but not limited to linear actuators, solenoids, as well as other mechanical and/or electro-mechanical couplings.

The first beam 81 is positioned on an outboard side of the first conveyor (and the second beam assembly may have a similar configuration or a mirror image configuration which may be positioned on the inboard or outboard side of the second conveyor).

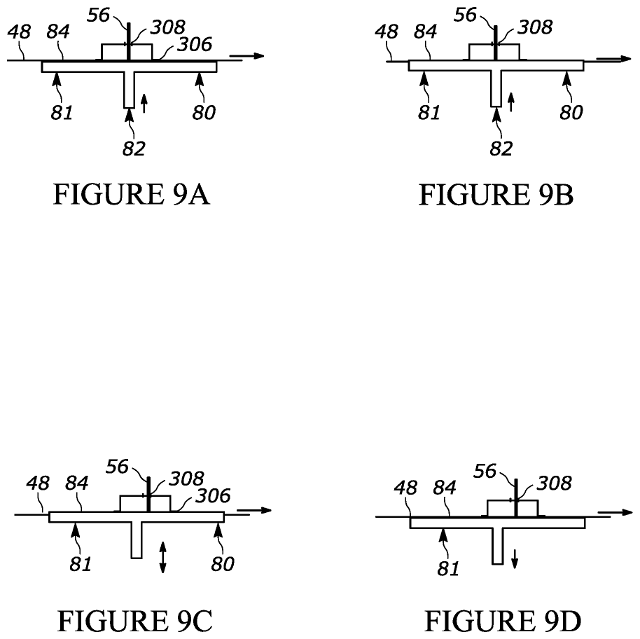

Operationally, and with reference to the schematic representations of FIGS. 8a through 8d, the cycle of operation of the position adjusting assembly of one configuration thereof, as described above will be set forth below. in an initial, resting configuration, the part contact edge 84 is configured to be positioned below (or to be lower, in the configuration shown) than the upper surface 50 of the conveyor links. In the configuration shown, the part contact edge 84 spans several of the conveyor links, near the second end of the first conveyor subassembly (although, the same may be positioned elsewhere along the conveyor). Through the eccentrically mounted configuration, the first beam travels through what appears to be a circular motion or both an upward and subsequently downward motion and also a rearward then forward motion. Through such motion, the position adjusting assembly interacts with the part and moves the part relative to the conveyor and the pins thereof into a desired orientation. Further operation of such a configuration as well as other configurations of the position adjusting assembly will be described hereinbelow.

It will be understood that the conveyor assembly can move parts from one location to another, and simultaneously have those parts positioned in a desired orientation. An exemplary part is shown in FIG. 1 as comprising part body 302 which is defined as spanning from first side 304 to second side 305 and which further includes a leading edge 306 and openings, such as first opening 308 and second opening 309. The part shown comprises a metal part and the conveyor is configured for use in an environment wherein a robot can pick up the metal part and transfer the metal part to a welding station. Of course, and as set forth above, the conveyor assembly is not limited to such use in association with such parts.

Once the part that will be conveyed on the conveyor is known, the conveyor can be adjusted to carry the desired part. For example, the first conveyor subassembly and second conveyor subassembly can be adjusted relative to each other in multiple manners. For example, the first conveyor subassembly can be moved closer or further from the second conveyor subassembly depending on the size of the part. It is preferred that a part be carried on the upper surface of the conveyor links of both of the first and second conveyor subassemblies. Of course, smaller parts may be positioned on only one of the first and second conveyor subassemblies.

In the configuration shown, to adjust the first conveyor subassembly relative to the second conveyor subassembly, the user can rotate the rotating adjustment handle 79 in a clockwise or counterclockwise direction with the understanding that rotation in one direction further separates the two conveyor subassemblies and rotation in a second opposite direction brings the two conveyor subassemblies toward each other.

The separation can be set based upon the position of the openings on the part, such as openings 308 and 309. For example, the spacing may be such that pins from the conveyor subassemblies can be positioned so as to extend through each of the openings or through some of the openings. In other configurations, the pins may push on the body from the side opposite the leading edge. In other configurations, a pin or multiple pins of one of the conveyor subassemblies can be directed through an opening of the part while a pin or pins of the other conveyor subassembly can push the part from the side opposite the leading edge. In still other configurations, multiple pins may extend through the part on one of the conveyor subassemblies, and the second conveyor subassembly may be utilized for support only (and no pins may abuttingly engage the part).

Once the conveyor subassemblies have been positioned in a desired relative orientation to each other, the pins of each of the conveyor subassemblies can be coupled to the desired conveyor links. That is, due to the independence of the first conveyor subassembly and the second conveyor subassembly, the pins that are utilized to retain a part on each of the conveyor subassemblies can be spaced apart from each other and do not need to correspond to each other along a transverse axis. Additionally, the conveyors can move at differing rates as the conveyors each have a drive motor that is independent. With the variable position of the conveyor links of the first conveyor subassembly with the conveyor links of the second conveyor subassembly and with the multiple bores (each of which can receive a pin) on each of the conveyor links, substantial flexibility to handle and convey parts of different configurations is provided with minimal reconfiguration of the components of the system (i.e., adjustment of the relative position of the conveyors and movement of the pins coupled to the conveyor links.

It will be understood that the openings of the part are larger than the pins of the conveying assemblies. To position a part in a position that is repeatable, it is desirable to have the part positioned so that the pins are pulling the part (or pushing the part if from behind) and that within an opening, the pin is at the forwardmost position in the opening (i.e., touching at a tangent line perpendicular to the direction of travel). With such positioning, when the robot picks up the part, the part is positioned sufficiently within a desirable window that facilitates the further processing (i.e., welding or other handling) of the part.

To aid in such positioning, and with reference to FIGS. 8a through 8d, the position adjusting assembly imparts and/or facilitates relative movement of the part and the conveyor linkages (and pins) to achieve the desired relative position. In the configuration shown, for example, as the part reaches the first and second beam assemblies 80, 90 are actuated. The action of the first beam assembly 80 will be described with the understanding that the movement of the second beam assembly is similar thereto (and in the configuration explained, simultaneous)The first beam actuator 82 is activated at the desired moment and the first beam is directed upwardly and into contact with the part. In greater detail, the part contact edge 84 is directed upwardly and into contact with the part. Further vertical movement essentially lifts the part off the upper surface of the conveyor links wherein it is supported by the first beam (and second beam). Further movement directs the first and second beams in a direction that is opposite to the direction of travel of the conveyor. It is contemplated that depending on the configuration, the conveyors may be permitted to continue movement, or they may stop, slow down, speed up or undertake another course of movement. As the first and second beams are directed rearwardly, the part likewise moves rearwardly. Eventually, the pins of the conveyors contact the part and the pins and/or the part are directed to so that they ear each at, near or within the desired acceptable limits of the desired location. Once this desired orientation of the part relative to the pin is reached (which may result in the pin moving the part in a longitudinal and/or transverse direction, the part will generally stop moving at such time relative to the pin (or the relative movement will typically be quite small). The continued movement of the first and second beams directs the first and second beams to move downwardly. Eventually, the beams are lowered sufficiently so that the part again rests on the upper surface of the conveyor links and is free from contact with the beams. Additionally, the part properly positioned relative to the pins.

It will be understood that depending on the relative motion and the starting and ending positions of the pins, the part and the beam, there may or may not be relative sliding of the part along the part contact edge of the beam. In some configurations, the relative movement is minimized such that once the desired position is reached, the pin and the part and the beam move in unison.

This can be repeated for each subsequent part that moves down the conveyor. It is also contemplated that a single conveyor may include multiple first and second beam assemblies that are positioned sequentially along the conveyor between the first and second ends thereof.

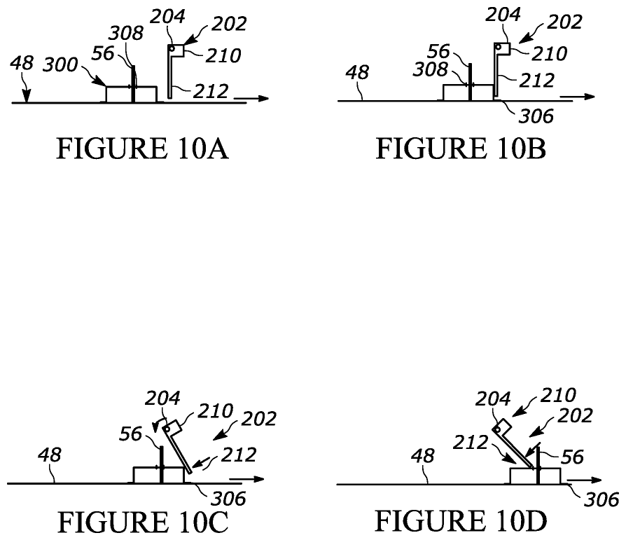

In other configurations, and with reference to the schematic representations of FIG. 9a through 9d, a similar configuration may be employed with the first and second beam assemblies. However, in that configuration, actuators may be configured to direct the first and second beams in an upward/downward motion, and not in the forward/rearward direction. Thus, in such a configuration, it is contemplated that the conveyor continues to move as the beam is directed upwardly (either at the same rate, a stop and go rate, a slower rate, a faster rate, among others) so as to direct the pin into the part as the part is lifted from the conveyor by the beam. Once the desired relative orientation of the part and the pins is reached, the beam may be lowered to release the part back onto the conveyor. As with the configuration of FIGS. 8a through 8d, depending on the relative position and the relative movement, the part may or may not slidably move relative to the beam as the part is positioned in the desired orientation relative to the pins.

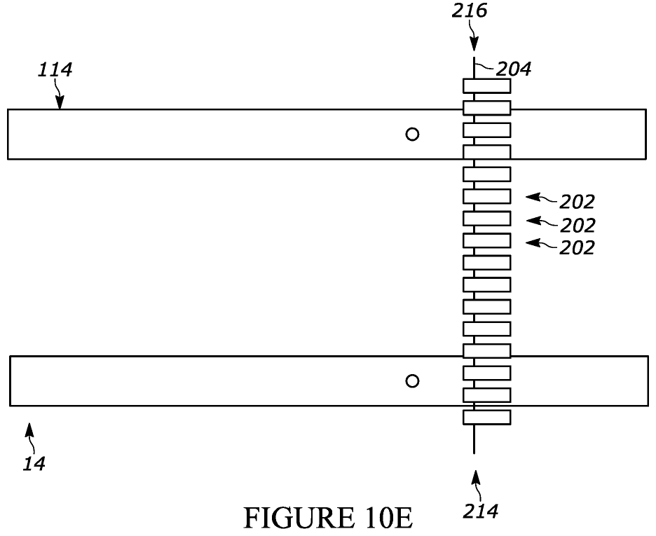

In another configuration, and with reference to the schematic representation of FIGS. 10a through 10e, the position adjusting assembly 18 may comprise a plurality of downwardly projecting fingers 202 that are pivotably coupled to a pivot axle 204 that is positioned over and across the conveyor. The pivot axle 204, in the configuration shown, is positioned above and in the path of the first and second conveyor subassemblies in a location wherein interference from the pins of the conveyor subassemblies is precluded. In the configuration shown, the pivot axle is positioned so as to be transverse to the direction of travel of the conveyors of the conveyor subassemblies and the pivot axle is generally perpendicular, while, in other configurations, the axle may be oblique to the direction of travel of the conveyor. In the configuration shown, the pivot axle 204 extends from first end 214 to second end 216. It will be understood that the pivot axle may lie over the first and second conveyor subassemblies, or between the first and second conveyor subassemblies or over one of the conveyor subassemblies.

The downwardly projecting fingers 202 include proximal end 210 and distal end 212. The proximal end 210 includes an opening through which the pivot axle can be extended, such that the downwardly projecting fingers can pivot relative to the pivot axle.

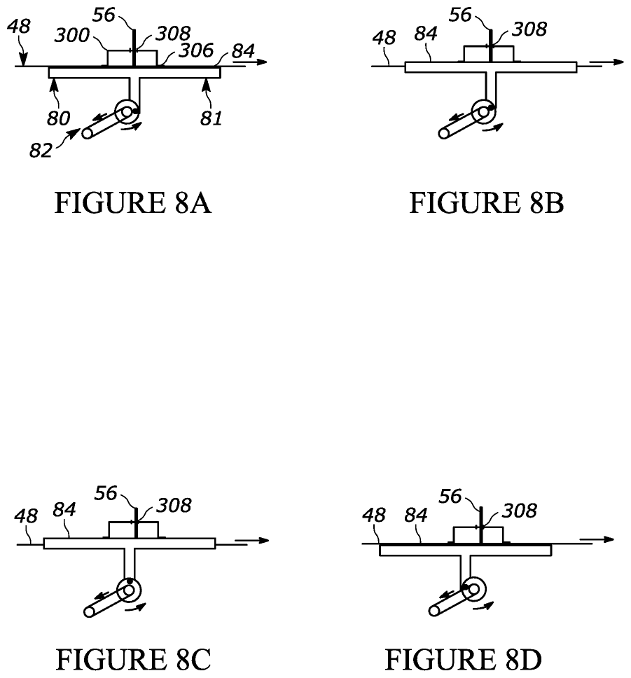

With reference to FIG. 7, the downwardly projecting fingers are configured so that they are directed into a vertical orientation and so that the distal ends extend sufficiently close so as to be able to engage the part, preferably without engaging the conveyor subassemblies. There may be a stop that is configured to maintain the downwardly projecting fingers the desired resting orientation. It will be understood that they are weighted in such a manner so as to apply a force in the direction opposite to the direction of travel (preferably) so as to direct the part to move into a desired orientation relative to the pins.

In the configuration shown, in operation, as the part is conveyed toward the second end, the part eventually contacts the distal ends of the downwardly projecting fingers. The fingers apply a force in a direction opposite the direction of travel of the conveyor links and pins. The part can overcome the force of the downwardly projecting fingers and rotate the downwardly projecting fingers out of the way so that the part can pass beyond the downwardly projecting fingers, however, the downwardly projecting fingers push the part relative to the conveyor links and the pin until the part is oriented in a desired configuration relative to the conveyor links and the pin. This again yields a predictable and repeatable position of the part relative to the conveyors and relative to the pins thereof.

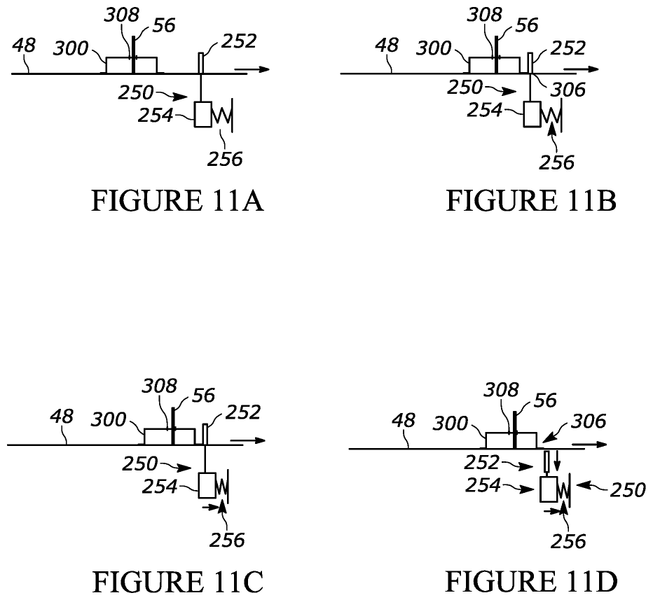

In yet another configuration of the position adjusting assembly which is shown in the schematic representation of FIGS. 11a through 11d, the position adjusting assembly 18 comprises pin assembly 250. The pin assembly 250 includes pin member 252, actuator 254 and biasing member 256. The pin member 252 is configured so as to extend vertically and into the path of the part 300. The actuator 254 selectively moves the pin member into and out of the path of the part 300. The biasing member 256 biases the pin assembly in a direction that has a component in a direction opposite the direction of movement of the conveyor.

In operation of such a configuration, the part proceeds on the conveyor toward the second end thereof. The actuator 254 directs the pin member 252 into a position that will be in the path of the part 300. Eventually, the part hits the pin member, and with the pin member biased by the biasing member in a direction opposite to the direction of travel of the part, the part is stopped (or at least slowed down) relative to the conveyor links and the pin. This relative movement of the part and the conveyor links and pin moves the part into a desired position relative to the pin(s) on the conveyor links (that is a known repeatable position). Once the position is reached (which can be determined by a sensor associated with the biasing member or with the pin assembly that senses an increase in force against the pin, due to the part coacting with the pin in the opening, for example (or behind an opening)), the actuator can retract the pin and move the pin out of the way of the part in the direction of travel of the conveyor links.

While the pin assembly is shown as coming from below the part, it is contemplated that the pin assembly can be coming from above the part. It is also contemplated that a given installation may have a number of different pin members positioned in different orientations on either side of either the first or the second conveyor subassembly.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A conveyor assembly for conveying a part therealong, the conveyor assembly comprising:
a frame;
a first conveyor attached to the frame, the first conveyor including a plurality of conveyor links coupled together, with a pin extending from a plurality of the plurality of conveyor links;
a second conveyor attached to the frame, the second conveyor including a plurality of conveyor links coupled together, with a pin extending from a plurality of the plurality of conveyor links; and
a transverse conveyor adjustment member associated with the frame, and, structurally configured to direct at least one of the first conveyor and the second conveyor in a first transverse direction and in a second transverse direction opposite to the first transverse direction, wherein the first transverse direction positions the first conveyor and the second conveyor closer to each other and wherein the second transverse direction positions the first conveyor and the second conveyor further apart from each other
the position adjusting assembly comprises a first beam assembly associated with the first conveyor and a second beam assembly associated with the second conveyor, the first and second beam assemblies each including a beam movable relative to a respective one of the first and second conveyor, wherein the first beam assembly further comprises:
a first beam positioned to a first side of the first conveyor, the first beam having a part contact edge;
a first beam actuator coupled to the beam, the first beam actuator structurally configured to move the first beam relative to an upper surface of the first conveyor between a first position and a second position;
wherein, in a first position, the part contact edge is positioned below the upper surface of the first conveyor, and wherein, in a second position, the part contact edge extends above the upper surface of the first conveyor, and wherein the movement between the first and second positions comprises a linear movement in an upward and downward direction.

2. The conveyor assembly of claim 1 wherein the first conveyor further includes a first conveyor drive motor and the second conveyor further includes a second conveyor drive motor.

3. The conveyor assembly of claim 1 wherein the transverse conveyor adjustment member comprises a pair of lead screws associated with one of the first and second conveyors, wherein rotation of the pair of lead screws in a first direction directs the first conveyor closer to the second conveyor, and rotation of the pair of lead screws in a second direction directs the first conveyor further away from the second conveyor.

4. The conveyor assembly of claim 1 wherein the first conveyor and the second conveyor are parallel to each other.

5. The conveyor assembly of claim 1 wherein the pin is positionable in a plurality of positions on at least one of the plurality of conveyor links.

6. The conveyor assembly of claim 1 further comprising:
a position adjusting assembly, structurally configured to engage a part on the conveyor so as to facilitate movement of the part relative to the conveyor.

7. (canceled)

8. (canceled)

9. (canceled)

10. (canceled)

11. The conveyor assembly of claim 1 wherein the movement between the first and second positions comprises movement that is in an upward and downward direction and also in a direction that is parallel to the direction of travel of the conveyor.

12. The conveyor assembly of claim 1 wherein the first beam assembly and the second beam assembly are substantially identical in configuration.

13. A conveyor assembly for conveying a part therealong, the conveyor assembly comprising:
a frame;
a first conveyor attached to the frame, the first conveyor including a plurality of conveyor links coupled together, with a pin extending from a plurality of the plurality of conveyor links;
a second conveyor attached to the frame, the second conveyor including a plurality of conveyor links coupled together, with a pin extending from a plurality of the plurality of conveyor links; and
a transverse conveyor adjustment member associated with the frame, and, structurally configured to direct at least one of the first conveyor and the second conveyor in a first transverse direction and in a second transverse direction opposite to the first transverse direction, wherein the first transverse direction positions the first conveyor and the second conveyor closer to each other and wherein the second transverse direction positions the first conveyor and the second conveyor further apart from each other;
a position adjusting assembly comprising a first beam assembly associated with the first conveyor and a second beam assembly associated with the second conveyor, the first and second beam assemblies each including a beam movable relative to a respective one of the first and second conveyor, wherein the first beam assembly further comprises:
a first beam positioned to a first side of the first conveyor, the first beam having a part contact edge;
a first beam actuator coupled to the beam, the first beam actuator structurally configured to move the first beam relative to an upper surface of the first conveyor between a first position and a second position;
wherein, in a first position, the part contact edge is positioned below the upper surface of the first conveyor, and wherein, in a second position, the part contact edge extends above the upper surface of the first conveyor, and wherein the first beam actuator further comprises a motor that is coupled to an eccentric drive configured to extend through a full rotation so as to direct the first beam in an upward and downward direction, as well as in a forward and rearward direction through the full rotation of the eccentric drive.

14. (canceled)

15. (canceled)

16. (canceled)

17. (canceled)

18. A conveyor assembly for conveying a part therealong, the conveyor assembly comprising:
a frame;
a first conveyor attached to the frame, the first conveyor including a plurality of conveyor links coupled together, with a pin extending from a plurality of the plurality of conveyor links;
a second conveyor attached to the frame, the second conveyor including a plurality of conveyor links coupled together, with a pin extending from a plurality of the plurality of conveyor links, and
a transverse conveyor adjustment member associated with the frame, and, structurally configured to direct at least one of the first conveyor and the second conveyor in a first transverse direction and in a second transverse direction opposite to the first transverse direction, wherein the first transverse direction positions the first conveyor and the second conveyor closer to each other and wherein the second transverse direction positions the first conveyor and the second conveyor further apart from each other,
a position adjusting assembly, structurally configured to engage a part on the conveyor so as to facilitate movement of the part relative to the conveyor, wherein the position adjusting assembly further comprises a pin assembly including a pin member selectively extendable into a path of a part, and an actuator directing the pin member into and out of the path of the part, and further including and further including a spring member extending between the frame and the actuator, the spring member biasing the actuator in a direction opposite that of the movement of the conveyor.

19. A conveyor assembly for conveying a part therealong, the conveyor assembly comprising:
a frame;
a first conveyor attached to the frame, the first conveyor including a plurality of conveyor links coupled together, with a pin extending from a plurality of the plurality of conveyor links;
a position adjusting assembly, structurally configured to engage a part on the conveyor so as to facilitate movement of the part relative to the conveyor, the position adjusting assembly comprising a first beam assembly associated with the first conveyor, the first beam assembly including a beam movable relative to a respective one of the first and second conveyor, wherein the first beam assembly further comprises:
a first beam positioned to a first side of the first conveyor, the first beam having a part contact edge;
a first beam actuator coupled to the beam, the first beam actuator structurally configured to move the first beam relative to an upper surface of the first conveyor between a first position and a second position;
wherein, in a first position, the part contact edge is positioned below the upper surface of the first conveyor, and wherein, in a second position, the part contact edge extends above the upper surface of the first conveyor, and wherein the movement between the first and second positions comprises a linear movement in an upward and downward direction.

20. (canceled)
